(19) United States
(12) Patent Application Publication
(10) Pub. No.: US 2020/0174592 A1
(43) Pub. Date: Jun. 4, 2020

(54) TOUCH DISPLAY DEVICE

(71) Applicant: Wuhan China Star Optoelectronics Technology Co., Ltd., Wuhan (CN)

(72) Inventors: Yuejun TANG, (US); Xueyun Ll, Wuhen (CN)

(73) Assignee: Wuhan China Star Optoelectronics TEchnology Co., Ltd., Wuhan (CN)

(21) Appl. No.: 16/333,230

(22) PCT Filed: Dec. 27, 2018
(86) PCT No.: PCT/CN2018/124334

§ 371 Date: Mar. 14, 2019

(30) Foreign Application Priority Data
Nov. 30, 2018 (CN) 201811449639.2

(51) Int. Cl. G06F 3/041

(52) U.S. Cl. CPC G06F 3/041

(57) ABSTRACT

A touch display device is provided and includes a back panel, a display screen body, a bezel, and a display touch layer disposed on a displaying region of the display screen body. A bezel touch layer is disposed on the bezel.

### FIELD OF INVENTION

The present invention relates to a field of display technologies, especially to a touch display device.

### BACKGROUND OF INVENTION

With development of electronic technologies, most electronic products, such as keyboards or mice for mobile phones, digital cameras, handheld game consoles, and instruments have been gradually replaced by touch screens. Touch screen solutions include a variety of solutions, such as plug-in and embedded typed touch panels.

Display devices, such as conventional display devices of mobile phones, only display parts of thereof have touch functions, which reduce the available area of the display device, and thereby reducing customer experience.

### SUMMARY OF INVENTION

### Technical Issue

Conventional display device only has a displaying portion with a touch function, which lowers an available area of the display device.

### Technical Solution

A touch display device comprises:

a back panel;

a display screen body;

a display touch layer disposed on a displaying region of the display screen body; and

a bezel;

wherein a bezel touch layer is disposed on the bezel; a function pattern icon is disposed on a place of the bezel corresponding to the bezel touch layer; and the bezel comprises a front bezel parallel with the display screen body and a side bezel located on a side portion of the display screen body, and the bezel touch layer is disposed on the front bezel and/or the side bezel.

Furthermore, the display touch layer and the bezel touch layer are individual from each other.

Furthermore, the display touch layer and the bezel touch layer are formed integrally.

Furthermore, the display touch layer is a detachable touch layer.

Furthermore, the display touch layer extends to a place corresponding to the front bezel to form the bezel touch layer.

Furthermore, the display touch layer extends to a place corresponding to the front bezel and a portion of the side bezel to form the bezel touch layer.

Furthermore, an edge of the display screen body extends to a place corresponding to a portion of the side bezel; the display touch layer extends to a place corresponding to at least a portion of the side bezel to form the bezel touch layer.

Furthermore, an edge of the display screen body extends to a place corresponding to the side bezel, the display touch layer extends to a place corresponding to the side bezel to form the bezel touch layer.

A touch display device comprises:

a back panel;

a display screen body;

a display touch layer disposed on a displaying region of the display screen body; and

a bezel;

wherein a bezel touch layer is disposed on the bezel.

Furthermore, a function pattern icon is disposed on a place of the bezel corresponding to the bezel touch layer.

Furthermore, the bezel comprises a front bezel parallel with the display screen body, and a side bezel located on a side portion of the display screen body, and the bezel touch layer is disposed on the front bezel and/or the side bezel.

Furthermore, the display touch layer and the bezel touch layer are individual from each other.

Furthermore, the display touch layer and the bezel touch layer are formed integrally.

Furthermore, the display touch layer is a detachable touch layer.

Furthermore, the display touch layer extends to a place corresponding to the front bezel to form the bezel touch layer.

Furthermore, the display touch layer extends to a place corresponding to the front bezel and a portion of the side bezel to form the bezel touch layer.

Furthermore, an edge of the display screen body extends to a place corresponding to a portion of the side bezel; the display touch layer extends to a place corresponding to at least a portion of the side bezel to form the bezel touch layer.

Furthermore, an edge of the display screen body extends to a place corresponding to the side bezel, the display touch layer extends to a place corresponding to the side bezel to form the bezel touch layer.

### Advantages

The bezel touch layer is disposed on the front bezel and/or side bezel of the display device, and the bezel touch layer and the display touch layer can be individual components or can be formed integrally such that a touch function extends to the bezel of the display device, which increases available touch area of the touch display device and provides a user with more extensive and comfortable experience of use.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic plan view of a display device of an embodiment of the present invention;

FIG. 2 is a schematic cross-sectional view along line A-A in FIG. 1;

FIG. 3 is a schematic plan view of a display device of an embodiment of the present invention;

FIG. 4 is a schematic cross-sectional view along line B-B in FIG. 1;

FIG. 5 is a schematic view of a display device of a third embodiment at a first angle of view;

FIG. 6 is a schematic view of the display device of the third embodiment at a second angle of view;

FIG. 7 is a schematic structural view of a display device of a fourth embodiment; and

FIG. 8 is a schematic structural view of a display device of a fifth embodiment.

### REFERENCE NUMERALS

10 back panel; 20 display screen body; 30 display touch layer; 41 front bezel; 42 side bezel; 50 bezel touch layer; 60 function pattern icon.

### DETAILED DESCRIPTION OF PREFERRED EMBODIMENTS

Each of the following embodiments is described with appending figures to illustrate specific embodiments of the present invention that are applicable. The terminologies of direction mentioned in the present invention, such as “upper”, “lower”, “front”, “rear”, “left”, “right”, “inner”, “outer”, “side surface”, etc., only refer to the directions of the appended figures. Therefore, the terminologies of direction are used for explanation and comprehension of the present invention, instead of limiting the present invention. In the figures, units with similar structures are marked with the same reference characters.

The present invention aims at the technical issue that the conventional touch display device only has a displaying portion with a touch function, which lowers customer experience. The present invention can solve the above technical issue.

### First Embodiment

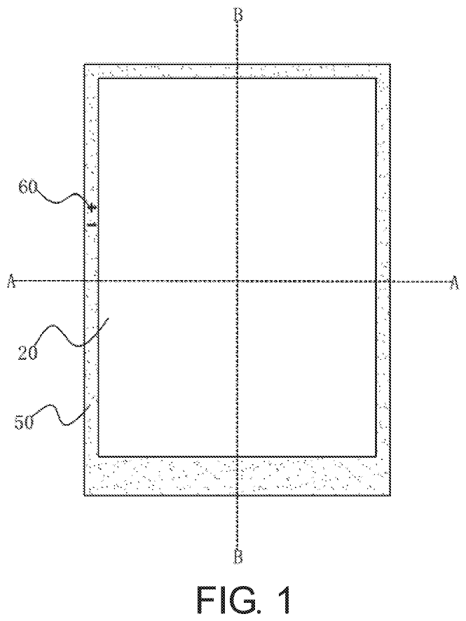

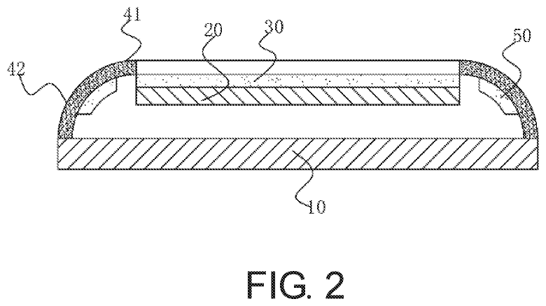

A touch display device, as shown in FIGS. 1 and 2, the touch display device includes a back panel 10, a display screen body 20, and a display touch layer 30 disposed in a displaying region of the display screen body 20. The touch display device further includes a bezel disposed around a periphery of the display screen body 20. The bezel covers an edge portion of the display screen body 20.

A bezel touch layer 50 is disposed on the bezel and is independent of the display touch layer 30.

By disposing the bezel touch layer 50 on the bezel, a touch area of the touch display device is increased, which can provide users with more extensive and comfortable experience of use.

Furthermore, a function pattern icon 60 is disposed on a place of the bezel corresponding to the bezel touch layer 50.

It should be noted that in a specific embodiment, the bezel touch layer 50 of the display device can be set with a touch function as required. For example, touch functions are set on left and right bezel portions of a cell phone to adjust volume. For example, a touch function is set on a lower bezel portion of a laptop or a desktop to control volume and brightness of the laptop or the desktop.

A setting wakening function is disposed on the display device for wakening the touch function of the bezel touch layer 50. For example, only when the display screen body 20 brightens can the touch function of the bezel touch layer 50 be used. Alternatively, only when two or more quick and continuous touches are applied to the same position of the bezel touch can the touch function of the bezel touch layer 50 be wakened up and can the touches of fingers be effective. Alternatively, only when a touch gesture is applied can the touch function of the bezel touch layer 50 be wakened to prevent the bezel touch layer 50 of the display device from being erroneously touched and controlled which influences user experience. For example, repeated erroneous touches on the touch position of the bezel occur when a cell phone is hand-held.

Specifically, the bezel includes a front bezel 41 parallel with the display screen body 20 and a side bezel 42 located on a side portion of the display screen body 20. The bezel touch layer 50 is disposed on the front bezel 41 and/or the side bezel 42.

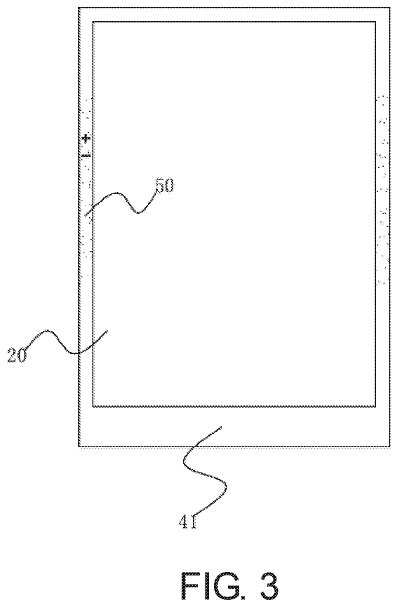

With reference to FIG. 3, a disposing position of the bezel touch layer 50 of the display device can be set as required. It should be noted that, FIGS. 1 and 3 only illustrate two position setting statuses of the bezel touch layer 50. In a specific embodiment, the bezel touch layer 50 can be disposed on a portion or a whole of one or more sides of the front bezel 41 and side bezel 42 of the display device.

It should be noted that a touch type of the bezel touch layer 50 is the same as or different from a touch type of the display touch layer 30. For example, the touch type of the display touch layer 30 is a capacitive touch type, the touch type of the bezel touch layer 50 can be a capacitive touch type or a resistive touch type, infrared detection touch type, surface acoustic wave detection touch type, electromagnetic induction detection touch type, or pressure sensing detection touch type. Other touch types will not be listed out herein.

### Second Embodiment

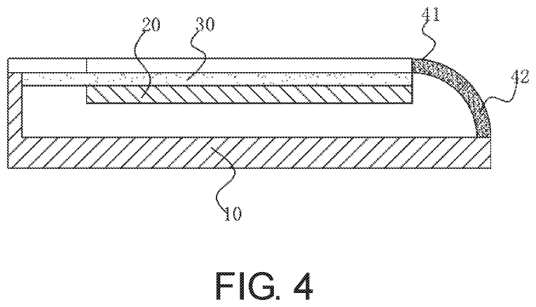

A touch display device is as shown in FIG. 4, and a difference thereof from the first embodiment is that a structural relation of the bezel touch layer 50 and the display touch layer 30 is different.

Specifically, a display touch layer 30 and a bezel touch layer 50 are formed integrally to facilitate manufacturing and lower a production cost.

Furthermore, the display touch layer 30 is a detachable (plug-in) touch layer. For example, by an adhering layer adhering the display touch layer 30 to the display screen body 20, the display touch layer 30 can be formed on an inner surface of an outer surface of a cover plate of the display device.

The display touch layer 30 extends to a position corresponding to a front bezel 41 to form the bezel touch layer 50.

### Third Embodiment

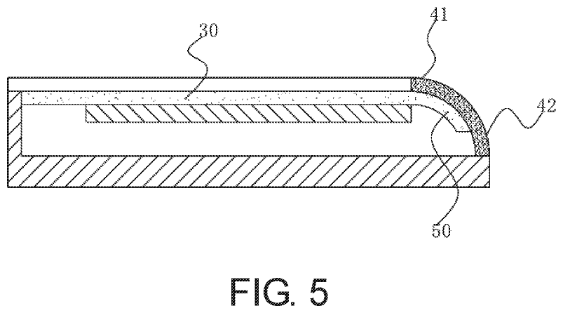

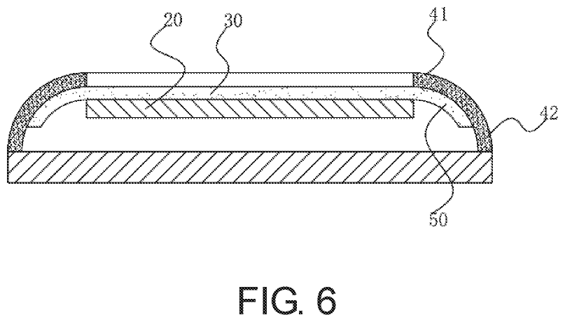

A touch display device is as shown in FIGS. 5 and 6, and a difference thereof from the second embodiment is that a place of the bezel touch layer 50 is different.

Specifically, a display touch layer 30 extends to a place corresponding to a front bezel 41 and a portion of a side bezel 42 to form a bezel touch layer 50.

### Fourth Embodiment

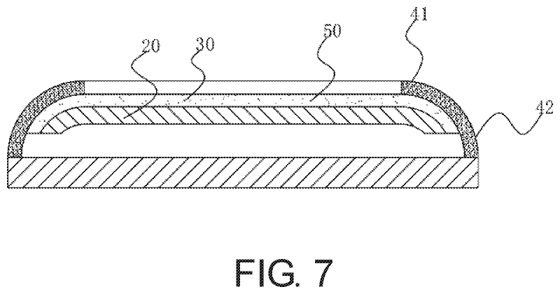

A touch display device is as shown in FIG. 7, and a difference thereof from the second embodiment is that positions of the bezel touch layer 50 and the display screen body 20 are different.

Specifically, an edge of a display screen body 20 extends to a place corresponding to a portion of a side bezel 42 to form a non-displaying portion. A display touch layer 30 extends to a place corresponding to at least a portion of the side bezel 42 to form the bezel touch layer 50. Furthermore, the bezel touch layer 50 partially covers, entirely covers or exceeds the non-displaying portion.

### Fifth Embodiment

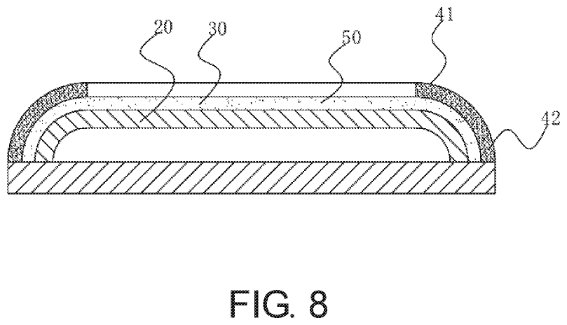

A touch display device, as shown in FIG. 8, and a difference thereof from fourth embodiment is that positions of the bezel touch layer 50 and the display screen body 20 are different.

Specifically, an edge of a display screen body 20 extends to a place corresponding to a side bezel 42 to form a non-displaying portion. A display touch layer 30 extends to a place corresponding to the side bezel 42 to form a bezel touch layer 50. Furthermore, the bezel touch layer 50 partially covers, entirely covers or exceeds the non-displaying portion.

Furthermore, the display touch layer 30 can be preferably an embedded touch layer. The edge of the display screen body 20 is set to extend to a predetermined position of the bezel such that the display touch layer 30 also extends to the bezel. That is to say that the non-displaying portion of the display screen body 20 serves as a carrier for the display touch layer 30 and extends to the predetermined position of the bezel. At the meantime, the bezel touch layer 50 partially covers, entirely covers or exceeds the non-displaying portion.

Advantages of the present invention are as follows. A bezel touch layer 50 is disposed on a front bezel 41 and/or side bezel 42 of a display device, and the bezel touch layer 50 and a display touch layer 30 can be individual components or can be formed integrally such that a touch function extends to the bezel of the display device, which increases available touch area of the touch display device and provides a user with more extensive and comfortable experience of use.

Although the preferred embodiments of the present invention have been disclosed as above, the aforementioned preferred embodiments are not used to limit the present invention. The person of ordinary skill in the art may make various changes and modifications without departing from the spirit and scope of the present invention. Therefore, the scope of protection of the present invention is defined by the scope of the claims.

What is claimed is:

1. A touch display device, wherein the touch display device comprises:
a back panel;
a display screen body;
a display touch layer disposed on a displaying region of the display screen body; and
a bezel;
wherein a bezel touch layer is disposed on the bezel; a function pattern icon is disposed on a position of the bezel corresponding to the bezel touch layer; and the bezel comprises a front bezel parallel with the display screen body and a side bezel located on a side portion of the display screen body, and the bezel touch layer is disposed on the front bezel and/or the side bezel.

2. The touch display device as claimed in claim 1, wherein the display touch layer and the bezel touch layer are individual from each other.

3. The touch display device as claimed in claim 1, wherein the display touch layer and the bezel touch layer are formed integrally.

4. The touch display device as claimed in claim 3, wherein the display touch layer is a detachable touch layer.

5. The touch display device as claimed in claim 4, wherein the display touch layer extends to a place corresponding to the front bezel to form the bezel touch layer.

6. The touch display device as claimed in claim 4, wherein the display touch layer extends to a place corresponding to the front bezel and a portion of the side bezel to form the bezel touch layer.

7. The touch display device as claimed in claim 4, wherein an edge of the display screen body extends to a place corresponding to a portion of the side bezel; the display touch layer extends to a place corresponding to at least a portion of the side bezel to form the bezel touch layer.

8. The touch display device as claimed in claim 3, wherein an edge of the display screen body extends to a place corresponding to the side bezel, the display touch layer extends to a place corresponding to the side bezel to form the bezel touch layer.

9. A touch display device, wherein the touch display device comprises:
a back panel;
a display screen body;
a display touch layer disposed on a displaying region of the display screen body; and
a bezel;
wherein a bezel touch layer is disposed on the bezel.

10. The touch display device as claimed in claim 9, wherein a function pattern icon is disposed on a place of the bezel corresponding to the bezel touch layer.

11. The touch display device as claimed in claim 9, wherein the bezel comprises a front bezel parallel with the display screen body and a side bezel located on a side portion of the display screen body, and the bezel touch layer is disposed on the front bezel and/or the side bezel.

12. The touch display device as claimed in claim 11, wherein the display touch layer and the bezel touch layer are individual from each other.

13. The touch display device as claimed in claim 11, wherein the display touch layer and the bezel touch layer are formed integrally.

14. The touch display device as claimed in claim 13, wherein the display touch layer is a detachable touch layer.

15. The touch display device as claimed in claim 14, wherein the display touch layer extends to a place corresponding to the front bezel to form the bezel touch layer.

16. The touch display device as claimed in claim 14, wherein the display touch layer extends to a place corresponding to the front bezel and a portion of the side bezel to form the bezel touch layer.

17. The touch display device as claimed in claim 14, wherein an edge of the display screen body extends to a place corresponding to a portion of the side bezel; the display touch layer extends to a place corresponding to at least a portion of the side bezel to form the bezel touch layer.

18. The touch display device as claimed in claim 13, wherein an edge of the display screen body extends to a place corresponding to the side bezel, the display touch layer extends to a place corresponding to the side bezel to form the bezel touch layer.
